(19) United States
(12) Patent Application Publication
(10) Pub. No.: US 2002/0055968 A1
(43) Pub. Date: May 9, 2002

(54) Distributed application interface and authentication process

(76) Inventors: Clayton Wishoff, Foster City, CA (US); Claudio Werneck, Raleigh, NC (US); James Louis Pearce, Concord, CA (US)

Correspondence Address: FLIESLER DUBB MEYER & LOVEJOY, LLP, FOUR EMBARCADERO CENTER, SUITE 400, SAN FRANCISCO, CA, 94111, US

(21) Appl. No.: 09/904,932

(22) Filed: Jul. 13, 2001

Related U.S. Application Data
(60) Provisional application No. 60/217,886, filed on Jul. 13, 2000.

(51) Int. Cl. G06F 15/16

(52) U.S. Cl. 709/203

(57) ABSTRACT

A distributed application interface and authentication system and method where the application interface accepts information identifying a particular user and the information is authenticated before granting access to a distributed computing network. The invention provides a method of linking two distinct applications operating in distinct environments so their collective information may be used for a common cause. A user attempting to login interacts with the web-based application. The system uses information from a web-based application as an input to a client-based application. Alternatively, the client-based application may contain information which can be used collectively by both applications to successfully authenticate or authorize a user.

This application claims priority from provisional application “Distributed Application Interface and Authentication Process”, application Ser. No. 60/217,886, filed Jul. 13, 2000, and incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS REFERENCE CASES

The following applications are cross-referenced and incorporated herein by reference:

U.S. Provisional Application entitled “Dynamically Configurable Graphical User Environment,” by Clayton Wishoff and Linda Byrne, Ser. No. 60/218,123, filed on Jul. 13, 2000; U.S. Provisional Application entitled “Application Container for a Graphical User Environment,” by Clayton Wishoff, Ser. No. 60/218,919, filed on Jul. 13, 2000; U.S. Provisional Application entitled “Notification Device for a Graphical User Environment,” by Clayton Wishoff, Ser. No. 60/218,095, filed on Jul. 13, 2000; and U.S. Provisional Application entitled “Software Application Agent Interface,” by Clayton Wishoff and Linda Byrne, Ser. No. 60/217,916, filed on Jul. 13, 2000.

### FIELD OF THE INVENTION

The invention relates generally to graphical user interfaces for computer systems, and specifically to systems and methods of enhancing the development and usability of such systems.

### BACKGROUND OF THE INVENTION

With the growth of Internet and satellite communications and the hardware and software which supports the same, there are a number of opportunities for companies which provide services and functionality for communicating information effectively between individuals and entities. By way of example only, one service provider, America Online, provides both Internet access as well as its own content. This provider targets a variety of user bases, including children, and derives most of its revenue from advertising. This provider provides a large amount of content and a user interface for its audience. In addition, this provider can leverage its log-in base network to address the demographics of its user base.

Another example which is used in schools is the Channel One System. This system operates an advertising-supported educational television service for secondary school students in the United States. Historically, the system brings news and current events for the schools by satellite, generating revenue from advertising interspersed in the programming.

Yet another example includes the Hughes Electronics System which offers satellite-based broadband Internet access for consumers. The system does not provide its own content. A further example of such a system is offered by Disney. This system offers a wide variety of Internet contact provided to children.

Accordingly, there still exists a need to build a broadband interactive network which is highly configurable and which can address the content and communication needs of a wide variety of private, educational, institutional, commercial and industrial environments.

### SUMMARY OF THE INVENTION

The invention relates to a system and method used to combine information from disparate systems in a distributed environment. It is a goal of the invention to provide a method of linking two distinct applications operating in distinct environments so that their collective information may be used for a common cause. An embodiment of the invention defines a system having a web-based login application, and a client or pc-based login application. A user attempting to login interacts first with the web-based application. The system uses information from the web-based application as an input to a client-based application. Alternatively, the client-based application may contain information which can be used collectively by both applications to successfully authenticate or authorize a user.

Other embodiments of the invention allow a computer system to interoperate simultaneously with both a web-based application and a client-based application. Variables may be collected in either application and/or used by the system or other applications to perform useful tasks.

### BRIEF DESCRIPTION OF THE FIGURES

The present invention will be described with references to the accompanying drawings, taken in conjunction with the following description wherein,

FIG. 1 illustrates the placement of the Jaguar server of an embodiment of the invention within a typical system environment.

FIG. 2 illustrates how components in the Jaguar server system of an embodiment of the invention interoperate with each another.

FIG. 3 illustrates a typical screen display produced by the Jaguar server on parsing a skin file of an embodiment of the invention.

FIG. 4 is a block diagram of an embodiment of the present invention.

FIG. 5 is a flow chart demonstrating the login function of an embodiment of the present invention.

FIG. 6 is a flow chart of an embodiment of the invention demonstrating the generation of a play-list for targeted advertising.

### DETAILED DESCRIPTION

Various embodiments of the invention will now be described with reference to the accompanying figures.

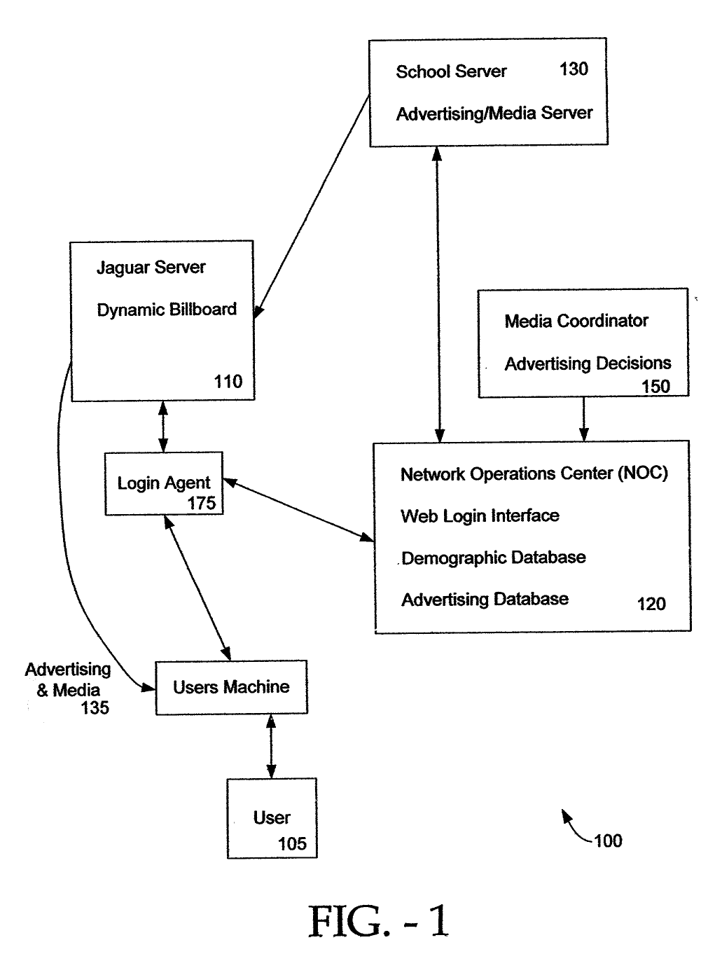

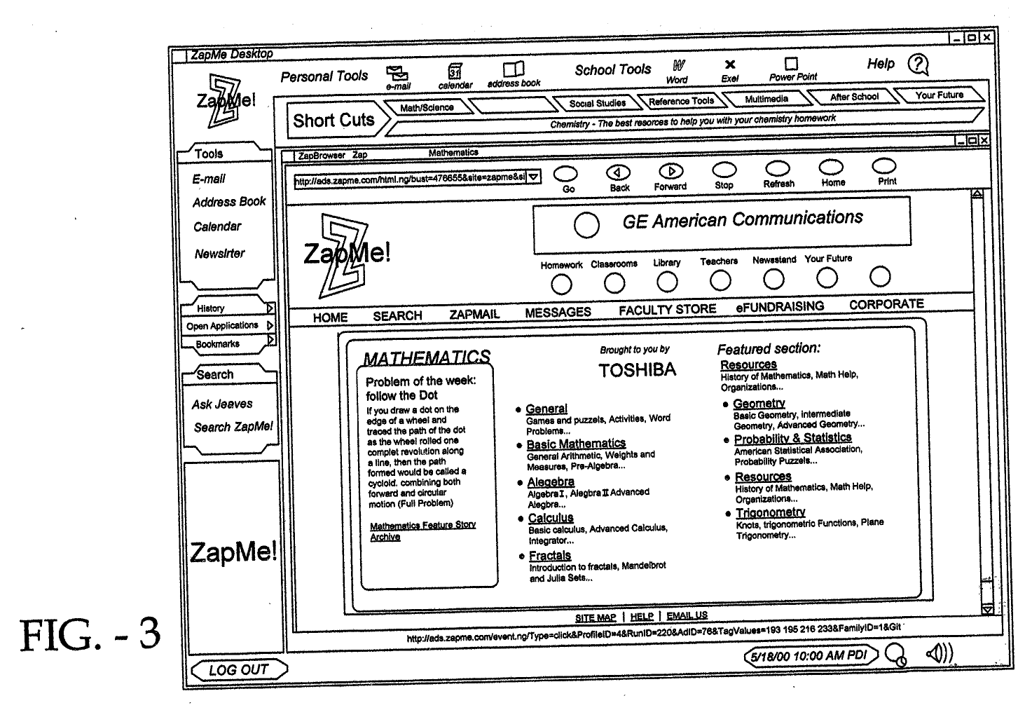

FIGS. 1-3

The Jaguar Graphical User Interface System

The invention as embodied relates to a series of novel enhancements and modifications for use with a distributed media communications and advertising system. Specifically, in the environment of a school, university, or other similar institution where many users may commonly share several user computers, or user machines, there exists current systems and methods to allow an advertiser to send, or otherwise display advertisements of their products or services on the user's computer. The invention describes a unique variant of such a system, together with a number of features which may further be used in other systems, by other vendors, and for other purposes.

The communications and advertising system embodied herein is known as “Jaguar Graphical User Interface”. Jaguar comprises a Server element, commonly called the “Jaguar Server,” “Jaguar” or simply the “Server”. The Jaguar Server operates upon the user's machine to generate display screens in accordance with defined rules and variables. Some of these rules may determine a user's access rights, the type of software application available to a user, or the advertising or news media information the user will receive.

The user interacts with the Server by means of an agent process, which can for example be a login process, a configuration process, etc. The Server similarly interacts with other Servers, such as mail Servers, and other entities (e.g. software applications), by means of similar agents. One common agent is a browser agent, which allows the user to access the Server in a browser or Net-like manner. The desktop environment may in this manner be thought of as a ‘Netspace’—a visual space or desktop through which the user interacts with the environment surrounding him.

An embodiment of the Jaguar system as it may be embodied in a school or educational environment 100 is shown in FIG. 1. As illustrated, a Jaguar Server 110 is in communication with both a centralized network operations center 120 and a school Server 130. Each of these components may have several sub-components, not shown here for clarity. In essence the Jaguar Server 110 utilizes information from a Network Operations Center NOC 120 to instruct the school Server 130 to customize the media, news, or advertising content 135 which the user 105, sees, dynamically and instantly, as determined by the instructions given to the NOC by a advertising/media coordinator 150. A database is maintained by the NOC, both for purposes of validating user logins, storing advertising information, and storing demographic information on each user so as to better target specific media/advertising.

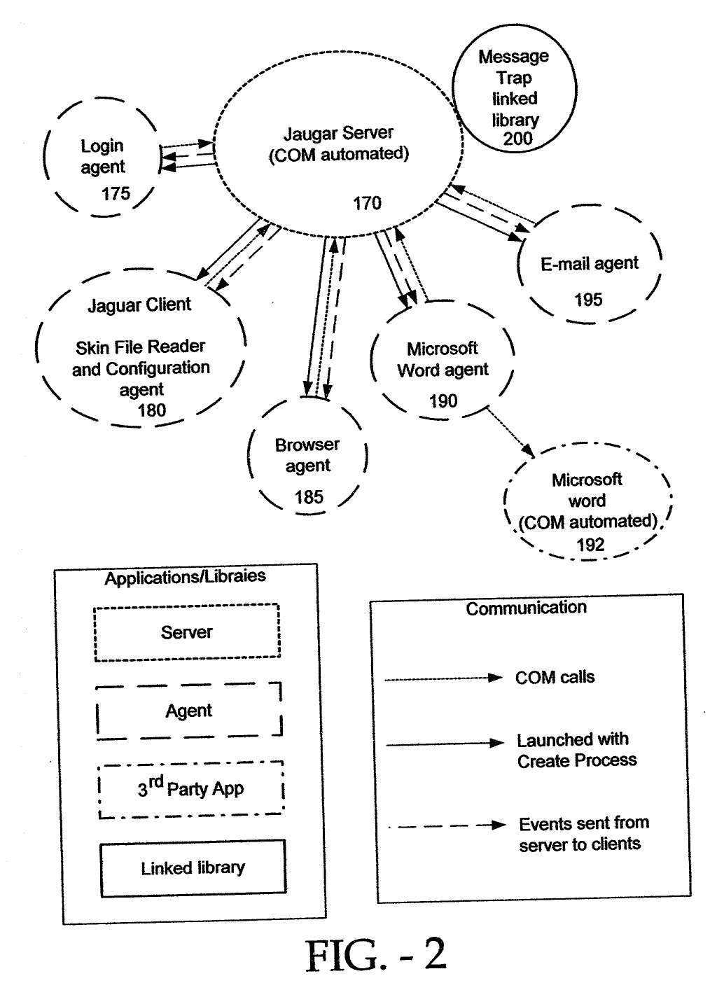

Focusing more on the Jaguar Server, the manner in which it interoperates and communicates with other processes is shown in FIG. 2. In this embodiment the Jaguar Server 170 may communicate with a login agent 175 to validate user logins and generate initial screens or Netspaces. A Jaguar client 180 reads skins to dynamically change the look and feel of the usual environment of the fly. Application agents 185, 190, 195 interact with the Jaguar Server, while a Message Trap 200 detects and notifies the user of actionable events. Some agents, such as a Microsoft Word agent 190 allows the Jaguar Server to make COM calls directly to the application (i.e. Word) itself. The key components of the system are as follows:

Jaguar Server 170

The Server is COM automated. COM is an architecture for defining interfaces and interaction among objects implemented by widely varying software applications. A COM object instantiates one or more interfaces, each of which exposes zero or more properties and zero or more methods. All COM interfaces are derived from the base class lUnknown. Technologies built on the COM foundation include ActiveX and OLE. The methods the Jaguar Server exposes are used to customize it's look and feel for different users. The Jaguar Server sends events to the client applications using an event sink that was initiated by the client. The Server is like the engine of a car, it works on its own but, without a frame and wheels it isn't very useful. The Configuration Agent is the frame and wheels, and the other clients are like options.

Jaguar Configuration Agent and Skin File Reader 180

The Jaguar Server launches the Jaguar Configuration Agent (client) at startup. The client then reads the skin file and instructs the Server via COM calls to create buttons, menus etc . . . The client then launches the login agent and any other agents the skin file requests. Any agent that is launched has the responsibility to connect to the Server in order to control it. This allows the Server to be independent of any agent. It also allows for multiple clients to control and effect changes in the Server.

Other Agents 175,185, 190, 195

The other agents in FIG. 2 are the login agent, the browser agent and the e-mail agent. All three agents act in the same way as the Jaguar Client except for one major difference. If one of these agents wants to launch an agent itself (i.e. The e-mail agent launches a browser agent) they send a request to the Server who launches it. This way all applications are launched in the same manner and can be kept track of by the Server.

Login Agent 175

At startup the Configuration reader instructs the Server to launch the Login Agent. The Server is primarily disabled (buttons are inactive and no ads are served) until the user has logged in. The login script launches a browser that's soul function is to control the log-in state. Once the user gives a correct username and password the Login Agent is hidden until logout and a Browser Agent is launched. When this new agent gets the username and login information in its URL it tells the Server that login was successful and items become enabled in accordance with the instructions from the Skin File. When the user logs-out or it times out then all open applications (except the Server and Configuration Agent) are instructed to close and the Login screen will reappear to log in the next user.

Browser Agent 185

The Browser Agent contains an Internet browsing window. This agent is used by the Server to display browsers that are task specific. The browser was created to support the Multi-browser Architecture. The Multi-browser architecture gives the user the ability to have more than one browser up at a time with its own forward and back state. In Internet Explorer or Netscape Navigator navigating can be cumbersome because all navigation occur in one primary window. With Jaguar the designer can have browsers that perform specific task like searching, e-mailing, updating their calendar etc. each in their own browsers with their own back/forward state. These windows are independent of any other browser. If the user selects the search button from the desktop (Server) the Server checks to see if a dedicated browser for search is already running if not it launches one otherwise it brings the search browser to the top. This feature makes users much more efficient and saves time.

E-Mail Agent 195

The E-mail Agent in one embodiment instructs the Server to launch a version of the Browser to be the container of the E-mail. The e-mail agent also controls the e-mail notification icon that may appear on the desktop. This icon on the Server will flash (animate) when the user has new unread mail. The e-mail agent is hidden and very small in size. It transparently controls the Server's e-mail icon. This is another example of the flexibility of the Jaguar Architecture.

Third Party Applications 190

The paradigm of having an agent that controls the communication between a server and a third party application (as seen in the diagram for Microsoft Word) is very powerful. Any third party application can be added to tbe ZapMe! product offering by simply installing the application and a very small agent. In the past entire servers would have to be changed in order to add applications.

Message Trap 200

The Message Trap literally traps all system messages and filters the messages related to window sizing and placement. It gets its parameters for the area to contain from the server who reads it from the skin file. The message trap also controls the information about the systems idle state. If the user moves the mouse or uses the keyboard then the idle state is reset. The Server will log the user out automatically if the idle state is more than a specified value (15 minutes is the default). The Server tells the message trap via a function call to set the containment area at a certain location and size. Any attempt to resize or move the windows to a location outside that area will fail. This guarantees advertisers that, while playing, their ads will not be covered up.

ZapMe! and Jaguar

Jaguar is the user's primary interface to the ZapMe! netspace and may be referred to as the “desktop”. The Jaguar interface is the starting point for all activities within the ZapMe netspace. Imaginative use of color, graphics and animations give the GUI an exciting look, while new and creative controls provide a fun experience. Jaguar also functions in the home market, giving a consistent look and feel to users whether at home or at school.

ZapMe! Client

The ZapMe! client, the user interface for the ZapMe! netspace, creates a set of features which gives access to the next generation of new technology. These new features and functions are so dynamic and compelling that kids are drawn to maximum use of the ZapMe! netspace. The ZapMe! netspace for school is delivered via satellite to each ZapMe! school. The ZapMe! netspace for the home is distributed via CD-ROM.

The ZapMe! netspace is a complete solution for the educational and entertainment lifestyle concerns for the targeted age group. This school and home product may be considered the “method of choice” for kids to communicate with their friends and to gather information about the world around them.

Jaguar Features

1. Desktop

In one embodiment, Jaguar is a window that is 1024 pixels by 768 pixels. This window will cover the entire screen and not have a title bar or borders. In effect it will be a full screen window whose client area extends to the edges of the screen. Jaguar may be set to run primarily in a 16-bit color mode (e.g. 65536 colors). While Jaguar will support 8-bit color mode (256 colors) it will not do so at the expense of the visual appeal of the 16-bit color version. For example, the 8-bit version may use a different set of skins than the 16-bit version so as not to impact the visual appeal of the 16-bit color version. Jaguar will still occupy (or attempt to occupy) the entire screen when the resolution of the Windows desktop is 1024×768 or 800×600.

2. Login

When Jaguar is started, the user is shown a login screen. The login screen resides in the Container Area and its function is to prompt the user for his/her name and password. All other Jaguar user interface features that accept user input will be disabled or display an alert dialog to remind the user to log in with the exception of the Reset (School environment)/Exit (Home environment) button as described in the section titled Exit Button.

3. Container Area

Jaguar is designed to have a large section of the screen reserved for the “Container Area”. The Container Area is the only area of the screen where applications launched by Jaguar can create their own windows.Jaguar can be directed to never allow any part of an application window to escape the Container Area. All operations on application windows (including moving, dragging, resizing, minimizing, maximizing, etc.) must keep the window constrained to this Container Area. In a school environment, the Container Area is typically set to be 800 pixels by 600 pixels. In a home environment, due to varying Jaguar desktop sizes, the Container Area may occupy an area that maintains the same distance from the Jaguar GUI controls as in the school environment.

4. Launch Pad

In one embodiment Jaguar provides a set of menus called the “Launch Pad” that incorporates the six major categories of activities available to the student, including: Communication, Entertainment, Tools, Lifestyle, eCommerce, and Content. Each menu contains submenu items that can be dynamically added via a configuration file. Menu items may also be added by applications launched by Jaguar. ZapMe! may deem activities on the Launch Pad inappropriate for either the home or school environment in which case the menu item for that activity may invoke a demo and/or promote the version of Jaguar where the option is available. Launch Pad items can include not only activities created in-house by ZapMe!, but activities created by third parties as well, for example MS Word and MS Excel. These third party applications should be well behaved. Well-behaved applications are applications that don't break the paradigm of Jaguar.

5. Open Apps Menu

Jaguar supports a menu that contains a list of all the open (e.g. running) applications. Selecting an item from the menu will bring the corresponding application to the foreground. Both Jaguar-aware and non Jaguar-aware applications may be listed in the Open Apps menu.

6. History Menu

Jaguar supports a menu that contains a list of all the documents the user has loaded called the “History”. All documents loaded into any Jaguar-aware application running within Jaguar will be automatically added to the History menu, no user interaction is required. The documents can be of a variety of types, including: MS Word, MS Excel (.xls), MS PowerPoint (.ppt), URLs that reference a specific web page. Essentially, any document that can be loaded into a Jaguar-aware application. The menu is hierarchical with the first level displaying a list of applications. The second level displays a list of documents that the corresponding application has loaded. Documents are added to the top of the second level menus such that the most recently accessed documents will be at the top of the menu. A document will never be listed twice in the same second level menu, but it is possible for the same document to be in two different second level menus if the document was loaded from two different applications. If a document is already listed, the old item is deleted from the menu before the new item is inserted. When a document is selected from the Document History menu it is loaded back into the application from which it was added (launching the application if necessary) and that application is brought to the foreground in the Container Area. The contents of the History menu are not saved across user sessions. When a user logs out the contents of the History menu is lost.

7. Bookmarks Menu

Jaguar supports a menu that contains a list of user selected documents called “bookmarks”. The documents in the Bookmarks menu can be any document that is included in the History menu. If it's listed in the History menu, then it can be added to the Bookmark menu. When a document is selected from the Bookmark menu, it is loaded back into the application from which it was bookmarked (launching the application if necessary). That application is then brought to the foreground in the Container Area. Each user account can maintain a separate list of bookmarks that are saved across sessions so that the user can logout and then log back in (possibly on another workstation) without any changes to the list of bookmarks. The first three menu items on the Bookmarks menu are reserved for bookmark administration and will be added automatically by Jaguar. Add Bookmark—this menu item will add the current document in the foreground application to the Bookmarks menu. Documents will never be added automatically to the Bookmarks menu. While the application may also have a way to add documents to the Bookmarks menu, a specific action on the part of the user is always required to add a document to the Bookmarks menu. Organize Bookmarks this menu item will navigate to a web page where the bookmarks may be moved, copied and deleted. The third item on the Bookmarks menu is a menu item separator to separate the administration functions from the actual bookmarks.

8. Notification Items

Jaguar provides the ability to display a set of “Notification Icons”. The Notification Icons will be arranged next to a small text display called the “Notification Window”. A Notification Icon can be associated with a specific application. An application does not have to be listed in the Open Apps menu (e.g. it doesn't have to be running) to have it's Notification Icon displayed. A Notification Icon can be designated to animate to alert the user that the application wants the user's attention. Together with the animating icon, a text message will be displayed in the Notification Window to give the user a more precise indication of the nature of the alert. In one embodiment double clicking or selecting a Notification Icon will bring that application to the foreground (launching the application if necessary). Double clicking the icon will have the same effect regardless of the alert state of the icon; essentially providing a short cut to the application. A single click on a Notification Icon will cancel a pending alert without bringing the application to the foreground. If multiple alerts are pending, the Notification Window can cycle the messages from all the pending alerts. Holding the cursor over a Notification Icon displays the name of the icon unless it is in an alert state. If the Notification Icon is in an alert state, it displays the alert text message instead.

9. Logos

Jaguar provides the ability to display logos. The logos may be animations that can be played, or set to display any frame in the animation, including for example uncompressed AVI files. When double-clicked, a logo can broadcast an event via Jaguar's event mechanism so that specific behaviors can be attached.

10. Ticker Tapes

Jaguar provides the ability to display single-line message windows called “Ticker Tapes”. A Ticker Tape can display text messages of arbitrary length, regardless of the size of the Ticker Tape window. A message will scroll smoothly across the Ticker Tape until the entire message is completely out of sight. When double-clicked, a Ticker Tape can broadcast an event via Jaguar's event mechanism so that specific behaviors can be attached.

11. Dynamic Billboard

Jaguar provides the ability to display HTML windows called “Dynamic Billboards”. A Dynamic Billboard displays advertisements and other HTML content to the user. The content displayed by the Dynamic Billboard will be dynamically configurable by ZapMe!. At no time is the Dynamic Billboard obscured by any other piece of Jaguar. Jaguar does not interfere or enhance the operation of the HTML window. The only exception is if the HTML window tries to create a new window, in which case Jaguar will redirect the navigation that attempted to leave the HTML window to the same URL but using ZapMe!'s proprietary browser. If the target of the navigation (the target is specified in the HTML code that tried to open the new window) is “ZapMeLaunch” (case sensitive), then the URL is assumed to be the name of a program which is then launched in the Container Area.

12. Date and Time

Jaguar displays both the date and the time to the user. Both the date and time can be the current date and time as reported by the computer (local time) or one of a variety of worldwide time zones. The format the date and time are displayed in is dynamically configurable by ZapMe!

13. About Box

Jaguar can display an “about” box, which contains, for example: The name and version number of the skin; Jaguar's version number; the name of the workstation Jaguar is running on; the IP address of the workstation Jaguar is running on; the IP address of the school Server where Jaguar is running; the screen name of the student logged in; and a copyright message.

14. Idle Time

After a dynamically configurable amount of time, Jaguar can be set to enter an idle mode. Jaguar will exit this idle mode if there is any keyboard or mouse activity. There is no built-in action upon entering or exiting idle mode; events are sent via Jaguar's event mechanism so that specific actions can be taken.

15. Background Bitmap

The user can set a specific bitmap to be the background of their user interface. This background is the basic element in which all other buttons, menus, etc. are placed.

Skin Files

Jaguar provides the ability to configure the desktop via a text file called a Skin. The Skin File provides the ability to create Jaguar GUI objects and attach pre-defined actions to various events that the objects generate. Using Skin Files, it is possible to create a desktop with a particular look, layout and behavior without making code changes to Jaguar.

Skin Files also provides the ability to change the look, layout and behavior based on information about the user who's logged in, and/or other configurable information available via Jaguar's Configuration API.

While the Skin File is text-based, it is stored in an encoded format so that inadvertent and/or malicious changes can not be made by non-ZapMe! personnel. The Skin File may include and/or exclude any of Jaguar's GUI features.

Logging

Jaguar logs all user activity to a file whose location is dynamically configurable by ZapMe!.

Architecture

Since the list of activities that Jaguar supports is not static, Jaguar needs to be expandable in a manner that is elegant and easy to maintain. Allowing a team of engineers to simultaneously work on different features without interfering with each other. To do this Jaguar follows a client/Server model using the COM Automation architecture. Jaguar itself will play the role of the Server, while the activities (also referred to as applets)are COM clients. Jaguar is a separate executable from the applets and each activity is implemented as a separate applet as well. This allows not only for individual development of each applet, but also allows us the creation of new applets, and therefore new activities, without having to modify Jaguar.

To allow the applets to communicate with Jaguar, Jaguar supports a variety of methods that enable the applets to manipulate the proprietary features of the Jaguar interface. These methods may be invoked using COM Automation technology. In addition, the applets will be notified of actions on the Jaguar interface though the use of COM events and event sinks.

Jaguar plays a central role in the user's experience. The user interacts with Jaguar to select among a variety of activities. In addition, Jaguar plays the role of coordinator allowing these activities to peacefully co-exist, not only with each other, but also with the proprietary features of the Jaguar interface. To do this Jaguar communicates with the applets providing the activities either directly, through a COM interface that the applet exports via Automation, or indirectly by hooking system services and filtering and/or translating messages sent to the applets by Windows itself. Applets that conform by providing a COM Automation interface, or that can be made to conform by hooking system services, are said to be well behaved. Well-behaved applets are applets that can be programmatically made to do the following: stay within the Container Area; be brought to the foreground; be minimized and restored; add documents they load to the History menu; bookmark documents that are currently loaded; load a specified document.

The challenge comes when 3rd party applets, applets not written by ZapMe! that don't communicate directly with Jaguar, are incorporated into Jaguar. Solutions to seamlessly integrate 3rd party applets can come from one of two directions:

The first solution involves hooking system services to monitor the activity of the 3rd party applet. This method can be used to monitor and act upon windows created by the applets. To that extent, constraining an applet to the Container Area, bringing it to the foreground, minimizing and restoring windows can be accomplished by filtering and altering certain messages sent to the applet's windows. Monitoring which documents are loaded by an applet and forcing an applet to load a particular document, while possible, are not well suited to hooking system services; that's where the second solution comes in.

The second solution involves creating an applet, called an agent, to act as a translator between Jaguar and a 3rd party program, referred to as the target of the agent. In this way, Jaguar doesn't need to know the specifics of 3rd party programs, it treats the agent just like any other applet, and it's the agent's job to make sure that the 3rd party program is well behaved. The methods that Jaguar supports are grouped into interfaces. Each interface provides access to a particular feature of Jaguar; most of which provide access to the proprietary features of the Jaguar interface such as notification icons and ticker tapes. By providing flexible interfaces, Jaguar creates a strong base on which to build.

Menu Interface

The menu interface allows access to the standard menus, which are guaranteed to exist, as well as allow an applet to create their own menus. Three different objects, menu buttons, menus and menu items define the menu interface.

Menu buttons are the anchor points for menus. Menu buttons are displayed on the screen and when pressed show their associated menu. It's also possible to create a menu button without a menu, in which case the menu button acts like a simple button. Menus are the centerpieces of the menu interface. Menus are simply containers that hold menu items. Menu items are where all the action takes place. Menu items can either perform generic actions, or they can have associated menu, in effect creating a sub menu.

Menu items don't have a preconceived idea of what will happen when they are selected (with the exception of a menu item that has an associated sub menu); they merely fire events back to the owner. It's the owner's responsibility to take appropriate action when they receive the event from the menu item. In this way, actions on menus can be whatever an applet desires. Jaguar uses the menu interface to create the Launch Pad; a set of menus that initiate activities. There are six main menus that make up the Launch Pad: Communication; Entertainment; Tools; Lifestyle; eCommerce; Content.

While Jaguar initially populates the Launch Pad menus, they are also be available to applets. Since Jaguar created the menus, the applets will not know the handles of the menus, which is required to add menu items to them. To accommodate this, the menu interface also accept a predefined menu ID (each Launch Pad menu will have a separate ID) in place of a menu handle.

History Menu Interface

The History menu contains a list of documents that the user has loaded. The menu is maintained automatically by Jaguar. No special action is required on the part of the user to add items to the History menu. Each document that is loaded by an application within Jaguar is added to the History menu. The History menu interface will prevent the menu from growing too long by automatically deleting older items from the menu. Selecting a document from the History menu will cause that document to be displayed in the foreground.

The History menu interface is implemented as a thin layer on top of the Menu interface to support the proper rules when inserting items into the History menu. These rules include that: New items are always inserted at the top of the menu, such that items accessed more recently will be at the top of the menu. When adding a document that already exists on the menu, the old menu item is deleted before the new menu item is added. When adding items to the History menu a normal menu item is returned. This menu item can be used just like any other menu item and be passed to any method listed in the Menu interface that takes a menu item.

The menu items returned by the History menu interface will not fire events back to the application that added the menu item because it's very likely that the application that added the menu item is no longer running. Instead, Jaguar determines if the application is still running. If the application is running the document name is sent via a ZapLoadDocument event to the application. If the application is not running, it is re-launched with the name of the document on the command line.

Bookmark Menu

The Bookmark menu contains a list of documents that the user has selected. Adding an item to the Bookmark menu requires a specific action on the part of the user. Any document that is loaded by an application within Jaguar can be added to the Bookmark menu. The Bookmark menu can have a hierarchical structure to help organize the user bookmarks. Selecting a document from the Bookmark menu will cause that document to be displayed in the foreground.

The Bookmark menu interface is implemented as a thin layer on top of the Menu interface to support features specific to the Bookmarks menu. These features include: inserting at the proper position; adding new bookmarks at the Server's request (as opposed to the clients' initiative); editing and organizing the contents of the bookmarks menu.

When adding items to the Bookmark menu a normal menu item is returned. This menu item can be used just like any other menu item and be passed to any method listed in the Menu interface that takes a menu item.

The menu items returned by the Bookmark menu interface will not fire events back to the application that added the menu item because it's very likely that the application that added the menu item is no longer running. Instead, Jaguar determines if the application is still running. If the application is running the document name is sent via a ZapLoadDocument event to the application. If the application is not running, it is re-launched with the name of the document on the command line.

Open Apps Menu

The Open Apps menu contains a list of applications that are currently running. Items are automatically added/deleted from the Open Apps menu as applications are launched/closed. Selecting an item from the Open Apps menu will bring that application to the foreground.

The Open Apps menu interface is implemented as a thin layer on top of the Menu interface to support features specific to the Open Apps menu. These features include such as inserting at the proper position.

When adding items to the Open Apps menu a normal menu item is returned. This menu item can be used just like any other menu item and be passed to any method listed in the Menu interface that takes a menu item.

Since the menu items are automatically added/deleted by Jaguar, the application doesn't get the events associated with the Open Apps menu items; Jaguar will get them instead. If an application is Jaguar-aware then it will receive a ZapAppToTop event. The application should respond to this event by bringing itself (or its target application in the case of agents) to the foreground. Applications in the Open Apps menu will also be asked to close; this is done by sending their top-level windows a WM_CLOSE message.

Jaguar determines if the application represented by an Open Apps menu item is Jaguar-aware by inspecting the ownerID associated with the menu item. If the ownerID refers to Jaguar, then Jaguar assumes that the application is not Jaguar-aware and attempts to manipulate the application (bring it to the foreground, closing it, etc), by making Window's calls with the application's processID. If it doesn't refer to Jaguar, then Jaguar assumes that it has been updated by the application, and is therefore Jaguar-aware. Jaguar will send the application events to request a specific action. An application updates the ownerID of the menu item by calling ZapOpenAppsItemSetLabel( ); therefore, a Jaguar aware application should update its label (even if it just calls ZapOpenAppsItemSetLabel() to get the current value) immediately after being launched.

Progress meter

A progress meter reflects to the user how much of a task has been completed and how much of the task is still left to do. A natural way to look at a progress meter is that it portrays how much of a task is completed via a percentage, 0% meaning that the task has just started, while 100% means that the task has been completed. Hence each progress meter will have a value, from 0 to 100, which represents how much of a task has been completed. This value can be updated manually by calling ZapProgressMeterSetPercentage( ), or automatically by calling ZapProgressMeterStartAuto( ).

Internally progress meters have two parts. The first part is the progress meter state engine. The state engine is responsible for maintaining the value of the progress meter and updating the value when the progress meter is being updated automatically via a call to ZapProgressMeterAutoStart( ). The state engine is responsible for everything but displaying the progress meter on the screen.

The second part is the progress meter animation engine. The animation engine is responsible for the graphical representation of the progress meter. It takes the current value of the progress meter and displays an image on the screen. Separation and isolation of the state engine from the animation engine is necessary to implement virtual progress meters. A virtual progress meter is a progress meter that doesn't have a visible representation. In other words, a virtual progress meter has a state engine, but not an animation engine.

Depending on the graphical representation of a progress meters, there may only be one progress meter that is visible at a time. For example, the progress meter may be represented by animating the ZapMe! logo on the Jaguar interface. This means that the single progress meter must be shared by all the applets. Sharing the progress meter is done by creating virtual progress meters when the real progress meter is already being used. A virtual progress meter will fire events and otherwise behave exactly like a real progress meter with the sole exception being that it isn't visible.

The Popup Question

The Popup Question interface will present a question to the user along with a list of possible answers. Each question will be displayed in a non-modal dialog window within the Container Area. The format of the popup question varies slightly based on the number of possible answers for a question.

Container Area

Since Jaguar supports various activities and other 3rd party applications, an area of the desktop is needed for these activities to display their own windows and present their own GUIs to the user. However, Jaguar will not allow any of these windows to overlap, or obscure, any other pieces of Jaguar. To accomplish this, an area of the desktop is set aside for these windows to reside. This area is called the Container Area.

The Container Area represents a large portion of the Jaguar desktop and is the only area where non-Jaguar windows may move about freely. Non-Jaguar windows may not leave the Container Area and attempts to move and/or resize (either manually or programmatically) these windows such that they extend past any boundary of the Container Area will not succeed. Inside the Container Area, however, Jaguar and non-Jaguar windows may be moved, resized, maximized, minimized, overlap, etc. such that the look and feel of the Container Area is that of the standard Windows desktop.

Dynamic Billboard

The Dynamic Billboard Interface provides the applets with a mechanism to display content to the user that can not be obscured. Dynamic Billboards appear on the Jaguar desktop, but outside of the Container Area so that the user's windows can not obscure them. Dynamic billboards are based on Internet Explorer ActiveX control and can display HTML content.

Jaguar will not interfere or enhance the operation of the HTML window. The only exception is if the HTML window tries to create a new window, in which case Jaguar will redirect the navigation that attempted to leave the HTML window to a Browser Agent Window displayed inside the container area.

Ticker Tape

The Ticker Tape Interface provides the applets with a mechanism to display messages to the user. The messages scroll smoothly across a single-line text window in a round-robin fashion. The caller has no control over when a message added to a ticker tape is actually displayed, but is informed when the message is displayed.

Notify Item

The Notify Item Interface provides the applets with a mechanism to notify the user of events that need a response or immediate attention. A notify item represents itself on the Jaguar desktop as a small icon. To notify users of events or conditions, small animations are played in place of the icon and a message is displayed in a single-line text window called the notify window. Clicking on the notify item's icon cancels all pending alerts and returns the icon to it's original image.

Clock

The Clock Interface provides the applets with a mechanism to display the date and time on the desktop.

Logo

The Logo Interface provides the applets with a mechanism to display animations on the desktop. The AVI video may contain audio, while the video supports any codec installed on the system.

Configuration

The Configuration Interface provides the applets with a mechanism to store configurable variables. The variables can then be changed by a configuration applet that can be run either locally or remotely. In any case, by isolating the applets from the mechanism that is used to store the data, Jaguar can shield the applets from any recurring changes that must be made to allow remote configuration.

Office Applications

Several Microsoft Office products and other third-party applications can integrate with Jaguar, including Word, Excel and PowerPoint. Each of these applications should be well behaved and integrate seamlessly with Jaguar. Being well behaved was discussed in the Architecture Overview at the beginning of this document. There is no interface that directly supports the Microsoft Office applications, rather this section will discuss the interfaces that the agents will use to link Jaguar with the MS Office applications. There are three areas in Jaguar that the agent must attend to; History, Bookmarks and Open Apps. The use of any other interface to implement additional functionality is at the discretion of the agent.

The agents that target the MS Office applications must be running at all times, even if the application they target has been closed. The reason behind this is that the agents must respond to menu item events to load documents, launching the target application if necessary.

History

The agent must place each document that is loaded by the application into Jaguar's History menu. This can be done with a call to ZapHistoryItemAdd( ). In addition, each time a document is brought to the foreground it must be re-added to the History menu so that it is positioned at the top of the History menu. The History menu interface will take care of making sure that duplicates are removed, etc. The agent must also respond to the ZapMenuItemSelectedo events that are sent out when items from the History menu are selected. When processing the event, the name of the document associated with the menu item can be retrieved using ZapHistoryItemGetDocument( ). Once an item is selected from the History menu it must be brought to the foreground in the application from which it was added. The appletPath parameter (in the call to ZapHistoryItemAd( )) should be used to identify the application that needs to load the document, rather than using the extension of the document to identify the application. In this way if two applications can load files of the same type, the document is loaded back into the application from which it was most recently used. For example; both Word and Excel can load files with the extension .xls, so assuming that Excel should load all documents with an extension of .xls is incorrect. Documents that are not currently loaded must be reloaded and then brought to the foreground. Documents listed in the History menu will remain in the History menu even if the document is closed from within the MS Office application. The agent must be capable of dealing with this case as well.

Bookmarks

The agent must add a name of the current document to the Bookmark menu at Jaguar's request. To do this, the agent must respond to the ZapBookmarkAddRequest( ) event by calling ZapBookmarkItemAdd( ) but only if the target application is in the foreground. If the target application is not in the foreground, the event must be ignored. The agent must also respond to the ZapMenuItemSelected( ) events that are sent out when items from the Bookmark menu are selected in the exact same way as was done for the History menu. Bringing them to the foreground, reloading if necessary, and using appletPath to determine the proper application.

Open Apps

The agent must place the name of the application it targets, not the name of the agent itself, into the Open Apps menu when the target application is started, using a call to ZapOpenAppsItemAdd( ). It must also remove this menu item when the application is closed, using a call to ZapOpenAppsItemDelete( ). The agent must also respond to the ZapMenuItemSelected( ) event from the menu item it added to the Open Apps menu by forcing the application to the foreground.

Distributed Application Interface

The Jaguar Server plays a central role in the user's experience. The user will interact with the Jaguar Server to select among a variety of activities. In addition, the Jaguar Server will play the role of coordinator allowing these activities to peacefully co-exist, not only with each other, but also with the proprietary features of the Jaguar Server interface. To do this, the Jaguar Server will be required to communicate with the applets providing the activities either directly, through a COM Automation interface (Agents), indirectly by hooking system services and filtering, or translating messages sent to the applets by Windows itself.

Applets that conform by providing a COM Automation interface, or can be made to conform by hooking system services, are said to be “well behaved”. “Well behaved” applets are applets that can be programmatically made to do the following: (1) stay within the Container Area, (2) be brought to the foreground, (3) be minimized and restored, (4) add documents they load to the History menu, (5) bookmark documents that are currently loaded, and (6) load a specific document.

The challenge comes when third party applets, those that do not communicated directly with the Jaguar Server, need to be incorporated into the Jaguar user interface. The solution is to provide an application agent.

The Agent is transparent to the user. The Agent receives input from the Jaguar Server engine to perform some action with the third party application (e.g. open a document). The Agent communicates with the third party application and informs the third party application that an event has been requested. Once the third party application, performs the requested event, then the Agent notifies the Jaguar Server engine as to the completion of the event. The Jaguar Server then informs the user that the event has completed (e.g. updating a document history list). The user, however, never perceives the Agent. The user perceives that the Jaguar Server engine communicated directly with the third party application to complete the user's request.

The Jaguar Server is equipped to handle an unlimited number of Agents. For each third party application incorporated with the Jaguar Server engine, a new Agent is created. By creating new Agents, or modifying old ones to accept new third party application functionality, the Jaguar Server engine is safe from unnecessary risks involved with testing. The Jaguar Server engine is not required to be modified every time there is a change in the third party application availability or functionality, thus saving time verifying only the agent, which is small and uncomplicated in comparison to the server which is quite complex. By limiting the changes to relatively uncomplicated, transparent Agents, the Jaguar Server engine's integrity is protected.

Additionally, added flexibility is given to the entire Jaguar Server system by using Agents over direct modifications to the Jaguar Server engine. As new third party applications are added to the Jaguar Server engine, an Agent is created. Agents are less complicated and require less time than making changes directly to the Jaguar Server engine. Thus, the Jaguar Server engine's architecture remains intact and error free by using Agents to communicate with third party applications rather than communicating with them directly.

When the Jaguar Server is first launched, however, it is instructed to launch the Login Agent. The Jaguar Server is primarily disabled (buttons are inactive and no advertisements are served) until the user has logged in. The login script launches a browser who's sole function is to control the log-in state. Once the user gives a correct username and password, the Login Agent is hidden until logout and a Browser Agent is launched. When this new agent gets the username and login information in its URL, it tells the Jaguar Server that login was successful and items become enabled in accordance with the instructions from the Skin File. When the user logs-out or the Jaguar server times out, then all open applications (except the Server and Configuration Agent) are instructed to close and the Login screen will reappear to log in the next user.

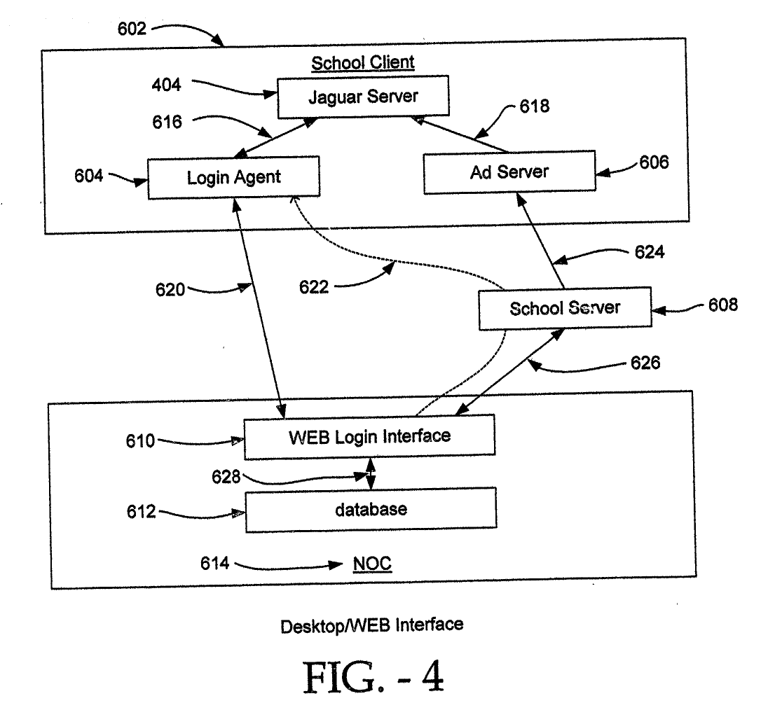

The application of a preferred embodiment of the present invention is best understood by referring to FIGS. 4-6 of the Drawings, wherein like numerals are used for like and corresponding parts of the drawings. In the following description, numerous specific details are set forth such as agents, applications, communication links, etc., in order to provide a thorough understanding of the present invention. It will be evident, however, to one of ordinary skill in the art that the present invention may be practiced without these specific details.

FIG. 4 illustrates, in the form of a block diagram, a system for linking two distinct applications operating in distinct environments so that their collective information may be used for a common cause in accordance with the present invention. The School Client 602 is the device that the user will have the most direct contact with. Within the School Client 602 reside the Jaguar Server 404, the Login Agent 604 and the Ad Server 606. Also depicted is the School Server 608 which primarily serves as a connection between the School Client 602 and the NOC (Network Operations Center) 614. Within the NOC 614 reside both the WEB Login Interface 610 and a database 612.

The Jaguar Server 404 remains in a ready state until the Login Agent 604 receives a correct username and password and authorization from the WEB Login Interface 610. The user inputs a username and password into the Jaguar Server 404 and this information is passed to the Login Agent 604. The Login Agent 604 passes the username and password to the WEB Login Interface 610 via Communications Link 620. This information may be passed along in a URL format or any other format that the WEB Login Interface 610 can understand. The WEB Login Interface 610 receives the username and password and then sends a query to the database 612 via Communications link 628. The database 612 compares the username and password with the appropriate record and returns to the WEB Login Interface 610 an access state of either a ‘valid’ or ‘invalid’ response to the username/password combination. The WEB Login Interface 610 passes the access state to the Login Agent 604. The Login Agent 604 then either instructs the Jaguar Server 404 to permit access or to deny access.

If the username/password are a valid combination, then the database includes information regarding the user's profile along with a ‘valid’ state. The user profile is provided to the School Server 608 which passes this information directly to the Ad Server 606. The Ad Server 606 contains a master file that holds all of the potential advertisements for a particular set of School Clients 602. With the user profile, the Ad Server 606 can be filtered such that only a dedicated group of advertisements are forwarded to the Jaguar Server 404. This allows for a more focused advertisement group to be sent to the user.

The NOC 614 and School Server 608 may also be used in combination to push new versions, applications, advertisements, utilities, etc., to the individual School Clients 602.

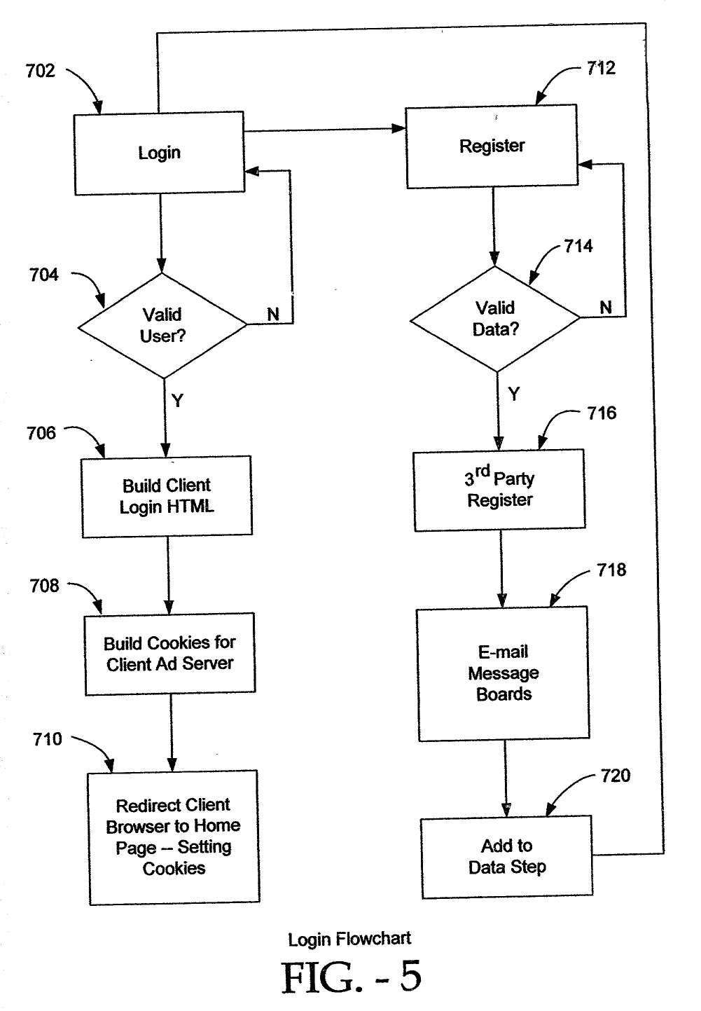

FIG. 5 shows a flowchart of the login function performed at login. Before an active user is using the Jaguar Server 404, the Login 702 is present and awaiting input. The user provides a username and password and this is compared to determine wether a valid user has logged in at 704. If the user is a valid user, then the School Client 602 is built by providing the Jaguar Server 404 the appropriate configuration commands in box 706. Also in box 706, a Login HTML file is pushed to the Jaguar Server 404. Next the login system creates the user profile cookies that contains information such as age, gender, location, etc. The cookies are forwarded to the Ad Server in box 708 for filtering of the primary database of advertisements contained in the Ad Server. Finally, box 710 redirects the School Client 602 browser to the appropriate home page and sets the cookies so that the targeted advertisements are displayed.

If the username/password combination was invalid then the user is redirected back to the login to reattempt. The user is required to enter certain demographic information in box 712. If the information provided by the user is insufficient, then box 714 will not let the user proceed and the data must be repaired by the user so that it becomes valid. If the correct information has been provided by the user, then box 716 creates the user's data record and effectively registers the user. The user's profile is then updated with e-mail access and various bulletin boards depending on the user's demographic information in box 718. Finally, box 720 completes the user profile and saves it to the system database and redirects the user to the login box of 702. The user may now proceed to enter his/her newly created username and profile to access the School Client 602.

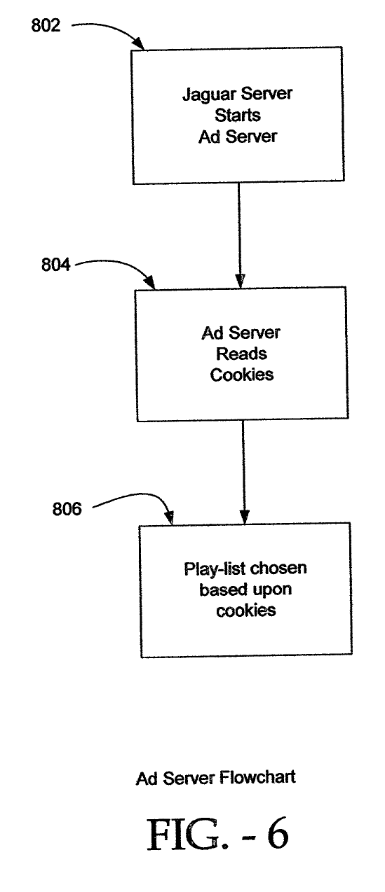

FIG. 6 shows a flowchart of the Ad Server. When the Jaguar Server is launched, the Jaguar Server initiates the Ad Server in box 802. The Ad Server is poised to accept the cookies created by the NOC based upon the user's profile in box 804. A play-list is chosen based upon the cookies in box 806. This may be created by filtering the Ad Server master list based upon the cookie information. This may also be done by creating a database as part of the Ad Server which contains a commonly used play-list and then modifying the play-list based upon the cookie information.

While the specific embodiment(s) of the present invention have been described above with regard to the best mode and preferred embodiment(s) contemplated by the inventor, it is to be appreciated that the present invention is not limited to the above embodiment(s) and that various modifications may be made to the above embodiment(s) without departing from the broader spirit or scope of the present invention as defined in the following claims. The specific embodiment(s) are, accordingly, to be regarded in an illustrative, rather than a restrictive sense.

Industrial Applicability

Example of System Used in a School Environment

The present system is a broadband interactive network used in order to create an educational environment using the latest technology tools and educational resources. This environment is particularly directed to schools and school districts. This system connects schools and school districts together through the Internet using satellite communication techniques. The present system is directed to making education more engaging and entertaining and providing a rich media computer experience which is easy to use. The system is expandable into homes which enhances the students' educational experience and creates better communication between students, teachers and parents. As indicated, the system has an easy-to-use and configurable interface that provides access to a multiplicity of Internet sites for indexing, with easy reference with respect to content, applications and services. The system also provides computer and word processing tools in addition to a range of communication tools including a network e-mail program. The present system provides a platform for the school community to engage in important activities, including providing teachers and administrators with access to Internetbased vocational content, cost-effective school e-Commerce solutions, and school fundraising opportunities.

The present system is easily configurable to a number of other environments with the benefits of networking, easy communication, and access to multiple Internet sites. By way of example only, the present system can be configured for just about any type of private, commercial or industrial need. For example, the present system could be configured to meet the needs of participants in the insurance industry, the medical industry, the automobile industry, the finance industry, and many many others. The configurable graphical user environment means that individuals with minimal computer knowledge would be able to configure the system for use in any of the above environments.

Other features, aspects and objects of the invention can be obtained from a review of the figures and the claims.

While the invention has been described herein with reference to a implementation referred to as Jaguar, and particularly with respect to the ZapMe! application; it will be evident to one skilled in the art that the invention may be equally used within other implementation and with other applications.

It is to be understood that other embodiments of the invention can be developed and fall within the spirit and scope of the invention and claims.

What is claimed is:

1. A system to enable communication between a server process and a client process in a graphical user interface environment of a computer system, comprising:
a server process for controlling the display of the graphical user interface;
a client process for communicating with a software application; and
an agent for providing an interface between the server and the clien, said agent receives input from the server process to perform an action with said software application and notifies the server process of the completion of the action.

2. The system of claim 1 wherein the server process is equipped to handle a plurality of agents.

3. The system of claim 1 further comprising:
a primary information source; and,
a cookie.

4. The system of claim 3 such that the cookie is used to filter the primary information source.

5. The system of claim 3 such that a play-list is generated by filtering the primary information source with the cookie's information.

6. The system of claim 1, further comprising:
an interface to accept an access information; and,
a verification system to authenticate the validity of the access information.

7. A method of enabling communication between a server process and a client process in a graphical user interface environment of a computer system, comprising:
providing a server process for controlling the display of the graphical user interface;
providing a client process for communicating with a software application; and,
providing an agent between the server and the client, said agent receives input from the server process to perform an action with said software application and notifies the server process of the completion of the event.

8. The method of claim 7 wherein the server process is equipped to handle a plurality of agents.

9. The method of claim 7 further comprising:
providing a primary information source; and,
providing a cookie.

10. The method of claim 9 such that the cookie is used to filter the primary information source.

11. The method of claim 9 such that a play-list is generated by filtering the primary information source with the cookie's information.

12. The method of claim 7, further comprising:
providing an interface to accept an access information; and,
authenticating the validity of the access information.
